(19) United States
(12) Patent Application Publication
(10) Pub. No.: US 2009/0078621 A1
(43) Pub. Date: Mar. 26, 2009

(54) System for Filtering and Removing Viruses From Water Supply Sources

(76) Inventors: Lionel Nicolai, Vitrolles (FR); Alain Nicolai, Allauch (FR); Marc Lassus, Marseille (FR); Robert Castro, Marseille (FR)

Correspondence Address: JAMES C. LYDON, 100 DAINGERFIELD ROAD, SUITE 100, ALEXANDRIA, VA, 22314, US

(21) Appl. No.: 12/085,583

(22) PCT Filed: Dec. 12, 2005
(86) PCT No.: PCT/FR2005/003103

§ 371 Date: May 28, 2008

(51) Int. Cl. C02F 1/32; C02F 103/22

(52) U.S. Cl. 210/86

(57) ABSTRACT

A system for filtering and removing viruses from water supply sources comprises a decontaminating unit (10) inserted between a water source (12) and at least one water supply source (14, 16, 18) of a closed space, a warning controller (36) used for displaying the misoperation of the decontaminating unit (10), which consists of three filters (20, 22, 24) for retaining particles, suspended materials (MES), colloidal substances and bacteria, and UVC radiation lamp (26) for destroying viruses. Pressure sensors (28, 30, 32) make it possible to measure a water pressure at the output of each filter and an UVmeter makes it possible to detect the UVC lamp misoperation. When the alarm controller receives an alarm signal from at least one pressure sensor or from the UVmeter, it closes a water closing means (38) arranged between the water source and decontaminating module.

### TECHNICAL DOMAIN

This invention concerns water supply virus filtering and removing systems, and concerns in particular avian flu virus removal from poultry husbandry water supply.

### STATE OF THE TECHNIQUE

Today, the possibility of a world pandemic through H5N1 virus linked to a possible avian flu inter-human propagation becomes a worldwide psychological obsession.

According to WHO, a world pandemic is unavoidable because it is likely that the H5N1 virus can exchange its genes with influenza viruses affecting humans. In that case, there would be a genetic rearrangement and the apparition of a new virus with a genetic equipment allowing such a dreaded inter-human transmission.

Governments and states have a pragmatic attitude, essentially focussed on human pandemic preventive actions. Consequently, they stock anti-viral drugs, like TAMIFLU, which efficacy against H5N1 virus has never been demonstrated, or FFP1 type masks whose effectiveness has been demonstrated only with hospital personnel. Similarly, a recent publication in the British Medical Journal has shown that a border control of travelers coming from endemic zones would be effective to detect 17% of them only.

According to the IOE (International Office of Epizootics) which, within WHO, is the world animal health organization, one of the most effective actions recognized to avoid a human pandemic, is to suppress or limit virus quantity in animals.

In developed countries, confinement measures in the event a livestock has not been previously contaminated, will be entirely effective. The only possible contamination vector, no yet controlled, remains poultry watering water, whatever the origin such water (rivers, lakes, pools, watertables, wellbores, wells . . . ).

### DESCRIPTION OF THE INVENTION

Therefore, the objective of the invention is to provide a system permitting to secure the water supplying confinement spaces such as poultry husbandries.

The object of the invention is thus a virus filtering and removing system for water supply including a decontamination unit interposed between a water source and at least one water supply source for a confined space, and an alarm controller appropriate to report a decontamination unit malfunction. Said decontamination unit comprises a first filter retaining particles and material in suspension (MIN) of a size greater than about 5μ, a second loaded cartridge type filter retaining particles, MIN, and colloidal substances of a size greater than about 0.5μ, a third ultrafiltration filter retaining microorganisms such as bacteria of a size greater than 0.1μ, and a UVC light to destroy viruses. Pressure sensors to determine water pressure at the outlet of each filter respectively, and a means of detecting UVC lamp malfunction, said means as well as said sensors being connected to said alarm controller. A means for shutting off water is placed between the water source and the decontamination unit. The alarm controller drives the water shut-off means when it receives an alarm signal from at least one of the pressure sensors or from the means for detecting UVC lamp malfunction.

### BRIEF DESCRIPTION OF THE FIGURES

The goals, objects, and characteristics of the invention will appear more clearly from reading the description that follows with reference to the drawings wherein

FIG. 1 represents a block diagram of a virus filtering and removing system for water supply according to the invention; and

FIG. 2 represents a block diagram of a centralized management system of several systems according to the invention illustrated in FIG. 1.

### DETAILED DESCRIPTION OF THE INVENTION

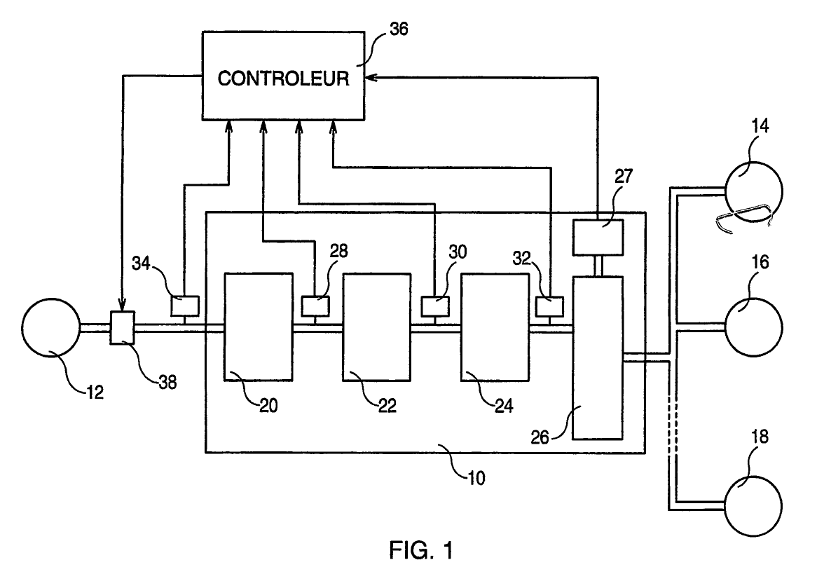

Referring to FIG. 1, a virus filtering and removing system according to this invention consists of a decontamination unit 10 through which circulates water to be decontaminated, received from a water source 12, i.e. the water distribution network. At the outlet of unit 10, decontaminated water is sent toward one or several water supply sources 14, 16, 18. Said sources provide decontaminated water to poultry husbandry enclosed spaces i.e. for chickens, in order to alleviate avian flu transmission.

Decontamination unit 10 comprises a series of three filters 20, 22, 24 and a UVC radiance lamp 26. Filter 20 retains particles, parasites, and materials in suspension (MIN) of a size greater than about 5μ, being understood that the terms “particles, parasites, and MIN” designate any elements of mineral, animal, or vegetal type. Filter 22 is a loaded cartridge type filter retaining particles and MIN of a size greater than about 0.5μ as well as colloidal substances. Filter 24 is an ultrafiltration filter designed to retain microorganisms as bacteria of a size greater than 0.1μ.

After passing through said three filters 20, 22, 24, water presents no more turbidity, because it no longer contains particles, MIN, colloidal substances, parasites, or microbial elements. One of the above factors, alone or in association, could cause a lack of effectiveness of the UVC lamp action on viral decontamination. The water which is subjected to UVC radiance may only include a few viruses. Those being no longer masked by more voluminous particles, such as above mentioned elements, will be completely deactivated by UVC radiance. This is particularly the case for all influenza A, B, C viruses, and in particular for influenza virus A H5N1, vector of the avian flu.

UVC lamp 26 emits at a wavelength of 250 to 256 nm. Its average emitting power is 60 mJoule/cm². As a reference, the dose necessary to deactivate a group A influenza virus is 6.6 mJoule/cm².

A UVmeter 27 reports continuously, as a percentage of the intensity emitted during the UVC lamp early life, the intensity received at the lamp least favorable point. It constitutes an efficacy indicator taking into account all parameters influencing performances such as lamp ageing, clogging of the quartz sheath covering the lamp, and water quality degradation.

Pressure sensors 28, 30, 32 are placed at the outlet of each filter in order to measure water pressure and thus detect any abnormal load loss (pressure decrease) i.e. due to clogging of corresponding filter, said load loss indicating a deviation from optimal working conditions.

A pressure sensor 34 is also positioned just before decontamination unit 10 in order to detect a pressure drop from water source 12, possible damaging the good operation of decontamination unit 10.

Sensors 28, 30, 32 and 34 as well as UVmeter 27 are directly connected to alarm controller 36, which can be a microprocessor programmed to receive alarm signals from the pressure sensors and UVmeter, and to transmit a water shut-off command to a shut-off device 38 placed at the outlet of water source 12. For effectiveness sake, only one signal received should be sufficient for the scanner to send a shut-off signal command to shut-off water supply sources 14, 16 and 18.

It is noteworthy that the controller determines immediately the deficient element when it receives alarm signals from the sensors. Indeed, if the pressure drop occurs at source 12, all sensors 34, 28, 30, and 32 send an alarm signal to the controller since the pressure drop reverberates in all filters of the unit. If only filter 20 is deficient, an alarm signal is transmitted by sensors 28, 30 and 32. If only filter 22 is deficient, an alarm signal is transmitted by sensors 30 and 32. Finally, if only filter 24 is deficient, only sensor 32 sends an alarm signal. Of course, an alarm signal coming from UVmeter 27 indicates poor operation of UVC lamp 26.

In order to be immediately informed of a decontamination unit malfunction, it is advantageous that the report of one, or several, of the filters or of the UVC diffuser malfunction be transmitted to the user. In order to achieve that, controller 36 is preferably connected to the user's computer through a WiFi, Blue Tooth connection, by carrier current or any other adequate linkage. Thus, the user who could be managing several decontamination units, will be warned by an alarm and/or a report appearing on his computer screen. He may then be able to immediately know which unit is deficient, and, within this unit, which filters need to be replaced, and whether the UVC lamp needs to be upgraded.

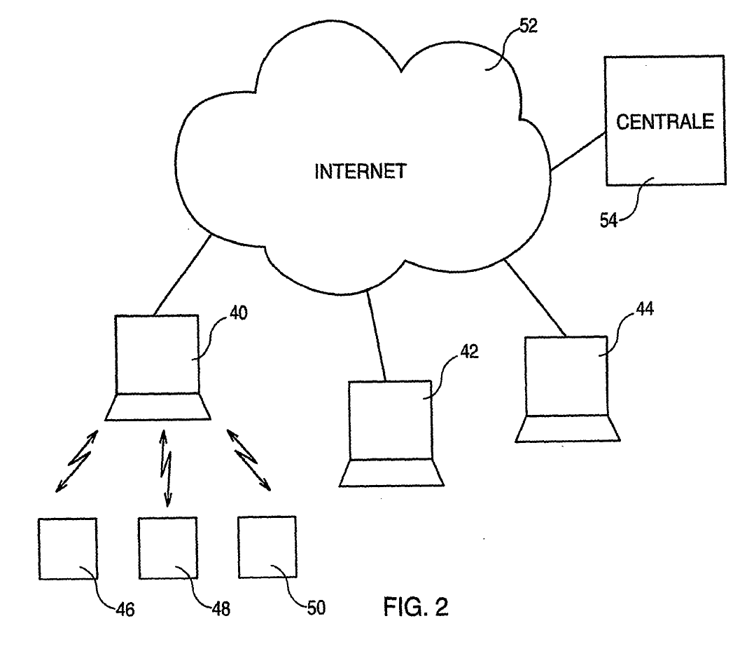

A unit centralized management system is illustrated in FIG. 2. Each user has a computer 40, 42, 44 as we have just seen. Each computer is continuously connected, i.e. by WIFI connection, to the alarm controllers under its control. Thus, computer 40 is connected by WIFI to three alarm controllers 46, 48, 50.

Computers 40, 42, 44 are connected to Internet network 52. An alarm center 54 is also connected to said Internet network. Its purpose is to receive alarms, as just described, from all computers it manages in a control point of a sort managed by a centralizing organ. Thus, as soon as an alarm report is received by alarm center 54, it knows the deficient unit location as well as the nature of the failure (whether the failing device is a filter or the UVC lamp) and so it can send on site a team for repairing the unit. Such a solution reduces to a minimum the costs of use.

1. Virus filtering and removing system for water supply comprising a decontamination unit interposed between a water source and at least one water supply source for an enclosed space, and an alarm controller adapted to report a malfunction of said decontamination unit, said decontamination unit being composed of a first filter retaining particles and materials in suspension (MIN) of a size greater than about 5μ, a second loaded cartridge type filter that retains particles, MIN, and colloidal substances of a size greater than about 0.5μ, of a third ultrafiltration filter retaining microorganisms having a size greater than 0.1μ, and a UVC radiance lamp to destroy virus;
wherein pressure sensors are provided to determine the water pressure at the outlet of each filter respectively, and a means of detecting UVC lamp malfunction, said means as well as said sensors being connected to said alarm controller,
and wherein a water shut-off means is placed between said water source and said decontamination unit, said alarm controller proceeding to shutting-off said water shut-off means when it receives an alarm signal from at least one of said pressure sensors or from said means of detecting said UVC lamp malfunction.

2. Device according to claim 1, wherein said malfunction detection means of said UVC lamp is a UVmeter indicating continuously, as a percentage of the intensity emitted during said lamp early life, the intensity being received from the least favorable point of the lamp.

3. System according to claim 1, further comprising a pressure sensor placed at the entrance of said decontamination unit in order to detect a decrease in water pressure provided by said water source, damaging the proper operation of said decontamination unit.

4. System according to claim 3, wherein alarm controller is a microprocessor programmed to determine immediately which is or are the failing filter(s) to be replaced when it receives one or several alarm signals from said pressure sensors.

5. System according to claim 4, wherein said alarm controller is linked to a computer available to the user, said computer displaying on its screen the filter(s) to be replaced, or whether the UVC lamp needs to be upgraded.

6. System according to claim 5, wherein said unit is used to protect poultry husbandry watering water.

7. Centralized management system of several systems according to claim 6, comprising several computers connected to Internet network, and receiving each the alarm signals from at least one decontamination unit, and an alarm center also connected to the Internet network, said alarm center being adapted to receive alarm signals from said computers in order to send on site a team assigned to repair the failing unit.

8. The system of claim 5, wherein said alarm controller is connected to said computer through a WiFi connection.
